(19) United States
(12) Patent Application Publication
(10) Pub. No.: US 2026/0306950 A1
(43) Pub. Date: Oct. 8, 2026

(54) A METHOD, DEVICE, SYSTEM, AND SOFTWARE FOR A COMPUTER-IMPLEMENTED METHOD FOR PLAYBACK OF GAME AUDIO BY USE OF REPRESENTATIVE AUDIO OBJECTS AT RUNTIME

(71) Applicant: DOLBY LABORATORIES LICENSING CORPORATION

(72) Inventors: Ziyu Yang, Beijing (CN); Zhiwei Shuang, Beijing (CN); Lie Lu, Dublin, CA (US); Yang Liu, Beijing (CN)

(73) Assignee: DOLBY LABORATORIES LICENSING CORPORATION, (US)

(21) Appl. No.: 19/477,979

(22) PCT Filed: Apr. 26, 2024
(86) PCT No.: PCT/US2024/026481

§ 371 Date: Oct. 23, 2025

Related U.S. Application Data
(60) Provisional application No. 63/499,678, filed on May 2, 2023.

(30) Foreign Application Priority Data
Apr. 28, 2023 (CN) 2023/091618

(51) Int. Cl. A63F 13/54; A63F 13/355; G10L 19/008; H04S 3/02; H04S 7/00

(52) U.S. Cl. CPC A63F 13/54; G10L 19/008; H04S 3/02; H04S 7/302; A63F 13/355; H04S 2400/01; H04S 2400/11; H04S 2400/13

(57) ABSTRACT

A computer-implemented method for playback of game audio by use of representative audio objects at runtime, comprising frame-by-frame the steps of, identifying candidate game audio objects based on non-silent in-game audio emitters, calculating a perceptual importance of each of the candidate game objects based on associated metadata, and generating a pre-set number of representative gaming audio objects based on the perceptual importance for playback of the game audio scene at runtime.

### CROSS-REFERENCE TO RELATED APPLICATIONS

This application claims the benefit of priority from PCT Application No. PCT/CN2023/091618 filed on 28 Apr. 2023, and U.S. Provisional Application No. 63/499,678, filed on 2 May 2023, each of which is incorporated by reference herein in its entirety.

### TECHNICAL FIELD

This disclosure relates generally to audio signal processing, and more specifically to the creation of representative gaming audio objects for efficient coding and/or rendering for various playback systems at runtime.

### BACKGROUND

To provide an immersive listening experience, object-based audio is becoming popular in-game sound design. In other fields beyond gaming, object-based audio has already become common, e.g., the Dolby Atmos techniques. The Dolby Atmos system introduced the object-based audio format that includes both beds and objects.

Audio beds refer to audio channels that are meant to be reproduced in predefined, fixed locations while audio objects refer to individual audio elements that may exist for a defined duration in time but also have spatial information of each object, such as position, size, etc. During transmission, beds and objects can be sent separately and then used by a spatial reproduction system to recreate the artistic intent.

However, since the reproduction system may be configured in many different ways when it comes to gaming, the recreation of the artistic intent might be hard to predict without compromising on the artistic intent of the gaming audio.

### BRIEF SUMMARY

An object of the present disclosure is to at least partly overcome the problem of compromising on the artistic intent of gaming audio when gaming at different reproduction systems.

According to a first aspect of the disclosure is a computer-implemented method for creating information associated with game audio and representative audio objects in an offline mode, comprising the steps of, dividing individual game audio sounds based on frames of the game, calculating for each frame, an excitation of at least one frequency band for the individual game audio sound, and arranging the calculated excitations in a game audio matrix according to the number of frames and the at least one frequency band of the individual game audio sound.

According to a second aspect of the disclosure is a computer-implemented method for playback of game audio by use of representative audio objects at runtime, comprising frame-by-frame the steps of, identifying candidate game audio objects based on non-silent in-game audio emitters, calculating a perceptual importance of each of the candidate game objects based on associated metadata, and generating a pre-set number of representative gaming audio objects based on the perceptual importance for playback of the game audio scene at runtime.

According to a third aspect of the disclosure is a decoder comprising a processor configured to perform the method according to the second aspect.

According to a fourth aspect is a device comprising a memory and a processor configured to perform the method according to any one of the first and/or second aspects.

According to a fifth aspect is a computer program having, instructions that when executed by an electronic device cause the electronic device to perform the method according to any one of the first and/or second aspects.

According to a sixth aspect is an audio system for playback of game audio by use of representative audio objects, comprising a memory and at least one pre-processor configured to perform the method according to the first aspect, and a memory and a processor configured to perform the method according to the second aspect.

In some examples, the metadata comprises an excitation, a position, a distance scale, a loudness, a sound object category, and/or a spatial relationship among candidate objects.

In some examples, the excitation is a modified excitation calculated based on an original excitation and a distance scale.

In some examples, the excitation is calculated by at least one frequency band.

In some examples, the excitation is extracted from a game audio matrix according to the first aspect.

In some examples, the loudness is calculated based on a masking of the excitation of the candidate game object in relation to another candidate game object.

In some examples identifying candidate game audio objects further comprises using a listener-centered trigger zone to identify the non-silent in-game audio emitters.

In some examples the non-silent in-game audio emitter's position, relative to a listener-centered position in the game, is converted to normalized Cartesian coordinates.

The present disclosure provides various technical advantages, such as a novel object-based audio handling framework for gaming that operates in real-time with no or a minimum quality reduction of the artistic intent of a game sound designer.

The present disclosure also allows for dynamic game audio runtime playback by pre-processing audio sounds by calculating excitation of the audio sounds in an offline stage, which reduces processing power at playback of the game audio at runtime.

The present disclosure further allows for dynamic game audio runtime playback by converting active sound emitters in the game and associated states to representative audio objects for game audio playback at runtime.

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

### BRIEF DESCRIPTION OF THE FIGURES

Examples of the present disclosure will be described in more detail with reference to the appended drawings. In the following drawings like reference numbers are used to refer to like elements. Although the following figures depict various examples, one or more implementations are not limited to the examples depicted in the figures.

FIG. 1 is a flowchart that illustrates a method for creating information associated with game audio and representative audio objects in an offline stage.

FIG. 2 is a flowchart that illustrates a method for playback of game audio by use of representative audio objects at runtime.

FIG. 3 is a flowchart that illustrates a method for playback of game audio by use of representative audio objects at runtime and a listener-centered trigger zone.

FIG. 4 illustrates a system for a method for creating information associated with game audio and representative audio objects in an offline stage and a method for playback of game audio by use of representative audio objects at runtime.

FIG. 5 illustrates a system comprising a mobile device and a cloud server connected to each other and wherein the cloud server creates and stores excitations for on demand retrieval by the mobile device for playback of game audio by use of representative audio objects at runtime.

### DETAILED DESCRIPTION

The principles of the present invention will now be described with reference to various examples illustrated in the drawings. It should be appreciated that the depiction of these examples is only to enable those skilled in the art to better understand and further implement the present invention; it is not intended for limiting the scope of the present invention in any manner.

Different from linear media, e.g., audio/video (A/V) or music, game audio is generated at runtime (as the player plays the game) using an audio engine running as a component of a game engine to obtain audio streams. Therefore, unlike linear narrative media, where the movement of objects is known in advance, information on where an object's position is in a game relative to a player's character is unknown. Therefore, the player's position in relation to an object in a gaming world is translated by the game engine at runtime.

Due to various limitations of different platforms or devices' capabilities, transmitting the original audio of the gaming world which may contain hundreds of individual audio files becomes challenging. This problem would become even more critical for mobile gaming since for example, a smartphone cannot allocate the smartphone's entire computational resource and memory for the mobile game.

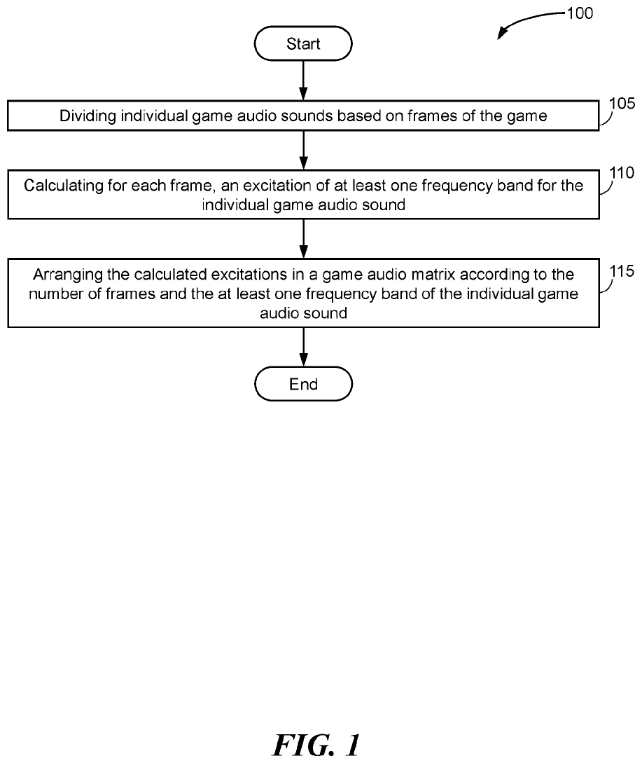

FIG. 1 is a flowchart that illustrates a method 100 for creating information associated with game audio and representative audio objects in an offline stage. The method comprises the steps of dividing 105 individual game audio sounds based on frames of the game, calculating 110 for each frame, an excitation of at least one frequency band for the individual game audio sound, and arranging 115 the calculated excitations in a game audio matrix according to the number of frames and the at least one frequency band of the individual game audio sound.

By calculating the excitation of the game audio sounds offline for all audio sounds in the game, the computational complexity at runtime is reduced since the excitation does not need to be calculated at runtime. The reduction in complexity will in some examples save at least the computation of one Fast Fourier Transform (FFT) per game audio sound at runtime.

Excitation as used in this disclosure relates to a representation of short-term loudness.

In an example, the audio sound is divided up into several overlapping gaming frames. For each frame, the excitation is calculated for at least one frequency band. The pre-calculated excitations can then be represented by an N_{f}-by-B matrix E_{f}, where N_{f} represents the number of overlapping frames and B the number of frequency bands of the audio sound f, respectively. It should be noted that the frame length and the number of bands B are preset and fixed for all sounds while N_{f} is file dependent.

In some further examples, a hierarchy structure of the audio sounds is defined by sound designers. The hierarchy structure defines the playback behavior of a group of sounds. For example, there could be several different audio sounds used for a “footstep”, which can be organized by a random container so that one footstep sound will be selected for playback if the sound effect is triggered at runtime.

The pre-calculated excitations may also be used as will be further described below in relation to the method 200 for playback of game audio by use of representative audio objects at runtime and more specifically when determining a perceptual importance of candidate game audio objects at runtime.

In some examples, an encoder comprises the method 100 of creating the game audio matrix.

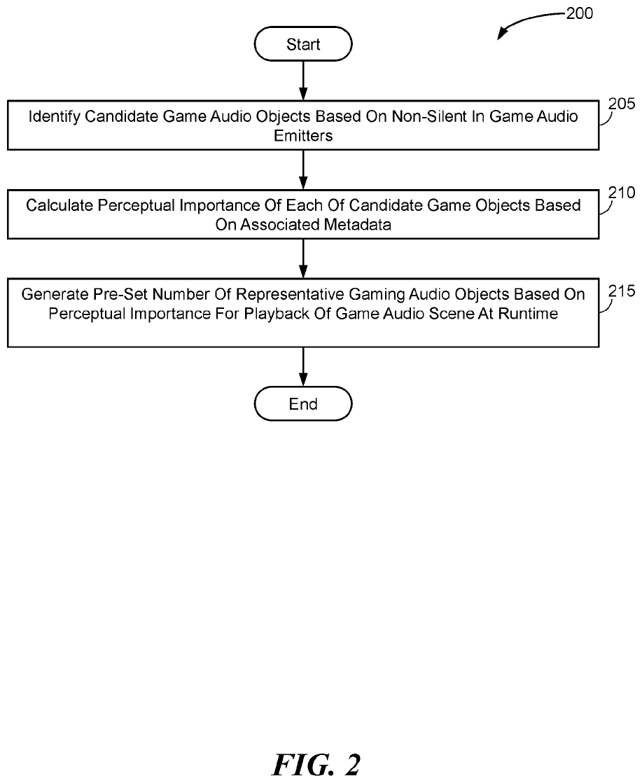

FIG. 2 is a flowchart that illustrates a method 200 for playback of game audio by use of representative audio objects at runtime. The method 200 comprising at frame-by-frame the steps of identifying 205 candidate game audio objects based on non-silent in-game audio emitters, calculating 210 a perceptual importance of each of the candidate game objects based on associated metadata, and generating 215 a pre-set number of representative gaming audio objects based on the perceptual importance for playback of the game audio scene at runtime.

The method 200 for playback of game audio at runtime allows for an adapted playback of complex gaming audio environments on different hardware, such as mobile phones with no or very low audio quality loss. The generation 215 of the pre-set representative gaming audio objects based on the perceptual importance enables adapting the audio playback of the gaming audio by linking the preset number to the available playback capability of the used hardware and/or software with low or less gaming audio quality loss. In some examples, the preset number is dynamically chosen based on available processing power. In some examples the preset number is chosen based on the hardware, automatically identified or pre-selected.

In some examples, the metadata comprises an excitation, a spatial position, a distance scale, a sound object category, a loudness, and/or a spatial relationship among candidate objects.

In some examples, the excitation of the candidate object is calculated at runtime. In other examples, the excitation of the candidate object is obtained by finding the excitation in the game audio matrix. For example, suppose the n-th frame of audio sound ƒ is the source audio for the candidate object i in operating frame t, then the excitation is obtained by getting the n-th column of a matrix E_{ƒ}, denoted by Eᵢ(n, b), b=1, . . . , B.

In an example, the spatial position is obtained by transforming a spatial position of the non-silent in-game audio emitters in the game world, relative to a listener-centered position in the game, to normalized Cartesian coordinates.

By converting the identified non-silent audio emitters to normalized Cartesian coordinates it is possible to use a standardized way of dealing with the non-silent audio emitters independent from for example of a game engine, platform, etc. For example, the normalized Cartesian coordinates may be the same as the ones used in Dolby Atmos.

Additionally, in an example, when transforming from the game world to normalized Cartesian coordinates, minimum and maximum distance thresholds can be set to determine the distance scale. Typically, the distance scale ranges from 0 to 1 as the distance varies from far (=1 if greater than the maximum threshold) to near (=0 if less than the minimum threshold).

For example, the distance scale may be helpful to distinguish if there are two objects with the same direction but having different distances related to the listener. The two objects may then end up in the same position (on the boundary) after the coordinate transform between the game world and the normalized Cartesian coordinates. Therefore, the distance scale may be stored as metadata together with the transformed spatial position. The transformed spatial position and distance scale for object i are denoted by pᵢ and dᵢ, respectively.

Further, the sound object category may be selected to represent different game actors or other sounds that are deemed to have the perceptually highest rank of the sounds in the game. For example, the sound object category is non-positional metadata indicating, for example, an animal attacking the player. In some examples, the game audio designer will have linked a real-time parameter control (RTPC) to the importance of the game sound. The sound object category of object i is denoted by cᵢ.

By using the sound object category, it is possible to preserve a specific category of audio objects such as, for example, sound effects belonging to the player character for more perceptual and realistic playback of the gameplay audio. Likewise, non-player sound effects may be categorized as belonging to a category of less perceptual importance and discarded for playback. Thus, the use of the sound object category may be used as a weight in relation to the preset number of representative audio objects such that it is possible to increase the likelihood of these types of audio sounds being selected for playback. The priority is usually indicated by the category information, which indicates that the objects belonging to the specific category are important from the designer's perspective.

One example of generating 215 the pre-set number of representative gaming audio objects will now be described in relation to a preferred example.

In the operating frame t, for any candidate object i, the excitation Eᵢ(b) is firstly attenuated by the distance scale dᵢ to get modified excitation Êᵢ(b) [1]:

$${\hat{E}}_{i} ( b ) = {d}_{i} {E}_{i} ( b ) \qquad ( 1 )$$

The importance of each candidate object can be determined by the loudness in the context of the audio scene. Specifically, for any given object i with excitation Eᵢ, the specific loudness

$${N}_{i}^{′} ( b )$$

of object i in auditory filter b can be calculated by [2]

$${N}_{i}^{′} ( b ) = {( A + {\sum }_{j} {\hat{E}}_{j} ( b ) )}^{α} - {( A + {\sum }_{j} {\hat{E}}_{j} ( b ) ( 1 - f ( i , j ) ) )}^{α} \qquad ( 2 )$$

where A, α are model parameters, and ƒ(i, j) represents the amount of masking, which depends on the spatial relationship between candidate object pairs i and j. The auditory filters used herein can be the filter banks containing overlapping bandpass filters. In psychoacoustics, such filter banks are used to mimic the frequency selection behavior of the cochlea. In general, candidate objects would mask other spatially close candidate objects. Therefore, the proposed function ƒ(i, j) should satisfy the following two principles:
1) The masking effect is only enabled if two candidate objects belong to the same sound object category, i.e., ƒ(i,j)=0, ∀cᵢ≠cⱼ;
2) If candidate objects are close enough by looking into their transformed positions p, the masking effect should become lower as the difference of their distance scale is becoming larger.

Therefore, a reasonable function to describe the masking effect can be

$$f ( i , j ) = \{ \begin{matrix}r ( {d}_{i} , {d}_{j} ) cos \frac{π}{2} \frac{‖ {p}_{i} - {p}_{j} ‖}{τ} , & {c}_{i} = {c}_{j} \\ 0 , & otherwise\end{matrix} \qquad ( 3 )$$

where τ∈(0,1) is a fixed cut-off threshold and

$$r ( {d}_{i} , {d}_{j} ) = ( {r}_{0} - 1 ) \vert {d}_{i} - {d}_{j} \vert + 1 \qquad ( 4 )$$

wherein r₀∈(0,1) is a fixed attenuation amount.

Then, the partial loudness of the object i is obtained by the sum of the specific loudness

$${N}_{i}^{′} ( b )$$

across all auditory filters b:

$${N}_{i}^{′} = {\sum }_{b} {N}_{i}^{′} ( b ) \qquad ( 5 )$$

which is served as the importance for candidate object i. Therefore, the candidate object with the maximum partial loudness is selected as the 1^{st} representative audio object. An associated audio waveform may then be retrieved from the corresponding audio frame of the audio source. The metadata of the selected candidate object may then also be used as the representative audio object metadata.

Then, for all remaining candidate objects, the excitation needs to be updated by

$${\hat{E}}_{i} ( b ) = {\hat{E}}_{i} ( b ) ( 1 - f ( i , {i}^{*} ) ) \qquad ( 6 )$$

where i* denotes the index of the just selected candidate object index.

With the updated excitations, the partial loudness of non-selected objects will be calculated again in the next iteration according to equations (2) to (6) for selecting the next representative audio object. This will continue until the iteration stops when the number of the representative audio object reaches the preset number of the representative audio object count.

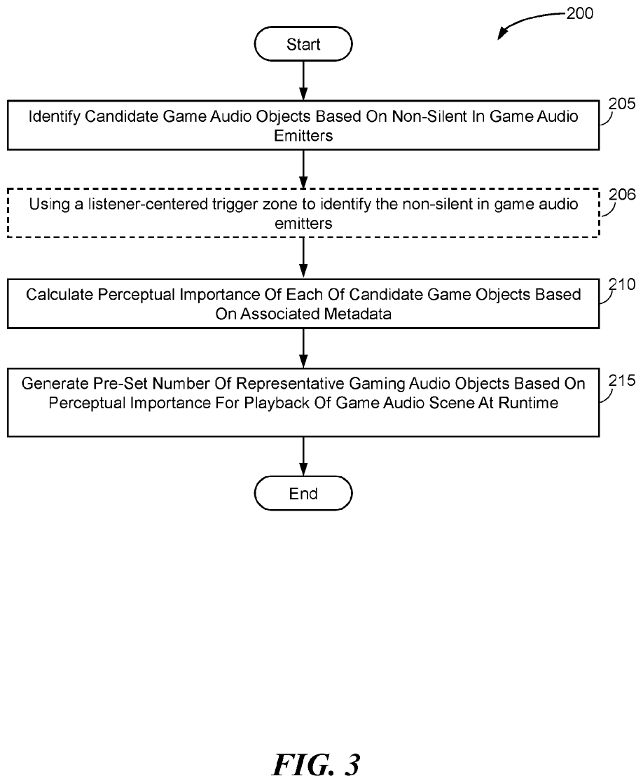

FIG. 3 is a flowchart that further illustrates an example of the method 200 to generate the pre-set number of representative gaming audio objects based on perceptual importance for playback of the game audio scene at runtime by identifying non-silent audio emitters by using 206 of a listener-centered trigger zone.

The use of a listener-centered trigger zone further reduces the need for processing power since the listener-centered trigger zone will act as a two-dimensional or three-dimensional filter that removes audio emitters that are not valid since they are arranged outside of the trigger zone.

For example, the trigger zone may be shaped as a sphere. The sphere will then normally be placed with a center of the sphere at the player's in-game gaming character. The sphere can be attached as a child component of the gaming character so that a transform, i.e., in-game location and/or rotation would be controlled by a parent component, normally being the character and which is controlled by the player.

Moreover, for example, the radius of the sphere could be defined by game developers and/or sound designers for better flexibility and sound experience for diverse gameplay. It would also be possible to design the shape in other ways by the game developer and/or sound designer. For example, the sound designers would in some scenarios focus on sounds coming from mainly the sides of the player character, other scenarios could be that the focus should be focused on sounds coming in front of the player character.

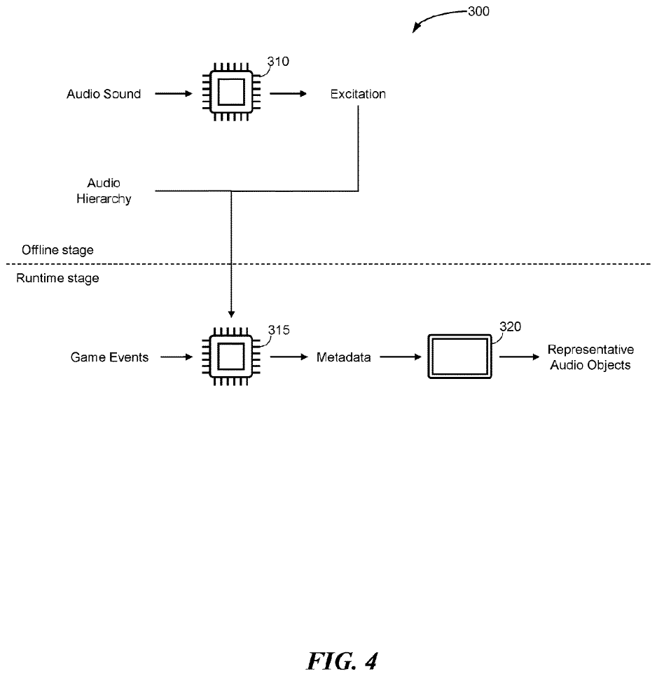

FIG. 4 illustrates an example of a system 300 comprising the offline stage as well as the generation of the representative audio objects at runtime.

The system 300 comprises a pre-processor 310 that is configured to execute the method 100 for creating the game audio matrix in the offline stage.

Further, the system 300 also comprises the method 200 for playback of game audio at runtime by use of a generator 315 for creating metadata based on game events and the game audio matrix. This is then input into an object selector 320 that is configured to generate the representative audio objects for runtime.

The pre-processor 310 may be combined with a memory and arranged in a server. In some examples, a processor comprises the generator 315 and the object selector 320 and is arranged in a mobile device. The server and mobile device are configured to communicate with each other.

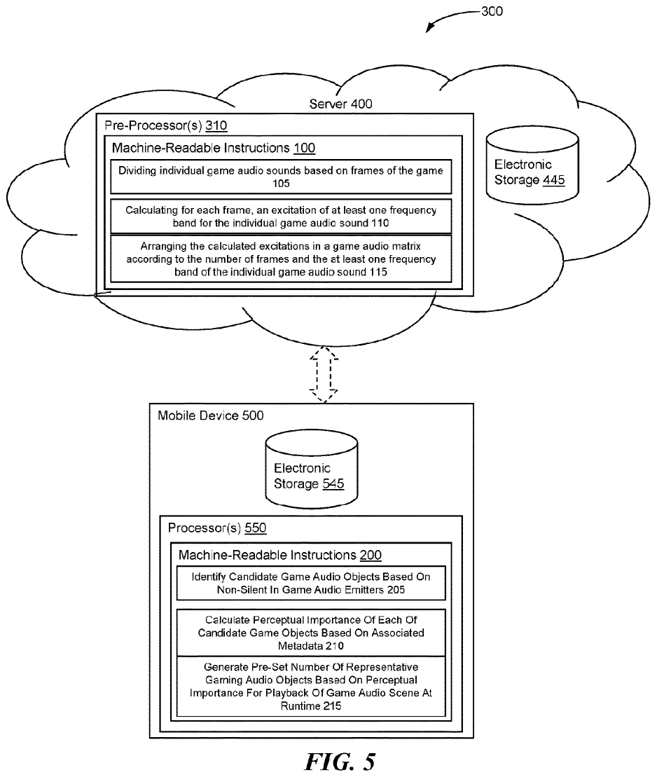

In an example, illustrated in FIG. 5, the server 400 and mobile device 500 are connected wirelessly to each other. For example, the game audio matrix will be generated and kept on the server 400 such that the mobile device 500 can get the representative gaming audio objects on demand. It would also be possible to in some examples have a partial download from the server 400 to the mobile device 500 of the representative gaming audio objects such that some of the gaming audio objects are ready for playback without the need for on-demand downloading. The number of downloaded gaming audio objects may be allocated based on the available electronic storage 545 on the mobile device 500.

In general, the calculation capacity and/or storage capacity can be divided between the server 400 and the mobile device 500 by a fixed relationship or dynamically set during playback of the gaming audio.

The examples of the system 300 may thus allow for a connected solution for cloud-based gaming where some computations are performed on the server 400 such that computing requirements of the mobile device 500 for playback of the gaming audio are lowered.

### FINAL REMARKS

In the claims below and the description herein, any one of the terms comprising, comprised of, or which comprises is an open term that means including at least the elements/features that follow, but not excluding others. Thus, the term comprising, when used in the claims, should not be interpreted as being limitative to the means or elements, or steps listed thereafter. For example, the scope of the expression of a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of examples of the invention, various features are sometimes grouped together in a single example, figure, or description thereof for the purpose of streamlining the disclosure and aiding in the understanding of one or more of the various inventive aspects. This method of disclosure, however, is not to be interpreted as reflecting an intention that more features are required than are expressly recited in each claim. Rather, as the following claims reflect, inventive aspects lie in less than all features of a single foregoing disclosed example. Thus, the claims following the Detailed Description are hereby expressly incorporated into this Detailed Description, with each claim standing on its own as a separate embodiment of this invention.

Furthermore, while some examples described herein include some, but not other features included in other examples, combinations of features of different examples are meant to be encompassed, and form different examples, as would be understood by those skilled in the art. For example, in the following claims, any of the claimed embodiments can be used in any combination.

Furthermore, some of the examples are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus is an example of a means for carrying out the function performed by the element.

Furthermore, some of the examples described herein disclose connected solutions which should be interpreted as being possibly implemented in a distribution and/or transmission system such as a wired and/or wireless system. For example by use of any electrical, optical, and/or mobile system, such as 3G, 4G as well as 5G.

Thus, while there have been described specific examples of the invention, those skilled in the art will recognize that other and further modifications may be made, and it is intended to claim all such changes and modifications. For example, any formulas given above are merely representative of procedures that may be used. Functionality may be added or deleted from the block diagrams and operations may be interchanged among functional blocks. Steps may be added or deleted to the methods described.

Systems, devices, and methods disclosed hereinabove may be implemented as software, firmware, hardware, or a combination thereof. For example, aspects of the present application may be embodied, at least in part, in a device, a system that includes more than one device, a method, a computer program product, etc.

In a hardware implementation, the division of tasks between functional units referred to in the above description does not necessarily correspond to the division into physical units; to the contrary, one physical component may have multiple functionalities and one task may be carried out by several physical components in cooperation.

Certain components or all components may be implemented as software executed by a digital signal processor or microprocessor or be implemented as hardware or as an application-specific integrated circuit. Such software may be distributed on computer-readable media, which may comprise computer storage media (or non-transitory media) and communication media (or transitory media).

As is well known to a person skilled in the art, the term computer storage media includes both volatile and non-volatile, removable and non-removable media implemented in any method or technology for storage of information such as computer-readable instructions, data structures, program modules, or other data. Computer storage media includes but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by a computer.

Further, it is well known to the skilled person that communication media typically embodies computer-readable instructions, data structures, program modules, or other data in a modulated data signal such as a carrier wave or other transport mechanism and includes any information delivery media.

Various aspects of the present disclosure may be appreciated from the following enumerated example embodiments (“EEEs”):

EEE 1. A computer-implemented method for creating information associated with game audio and representative audio objects in an offline stage, comprising the steps of,
dividing individual game audio sounds based on frames of the game,
calculating for each frame, an excitation of at least one frequency band for the individual game audio sound, and
arranging the calculated excitations in a game audio matrix according to the number of frames and the at least one frequency band of the individual game audio sound.

EEE 2. A computer-implemented method for playback of game audio by use of representative audio objects at runtime, comprising frame-by-frame the steps of,
identifying candidate game audio objects based on non-silent in-game audio emitters,
calculating a perceptual importance of each of the candidate game objects based on associated metadata, and
generating a pre-set number of representative gaming audio objects based on the perceptual importance for playback of the game audio scene at runtime.

EEE 3. The computer-implemented method of EEE 2,
wherein the metadata comprises an excitation, a position, a distance scale, a loudness, a sound object category, and/or a spatial relationship among candidate objects.

EEE 4. The computer-implemented method of EEE 3,
wherein the excitation is a modified excitation calculated based on an original excitation and a distance scale.

EEE 5. The computer-implemented method according to EEE 3 or EEE 4,
wherein the excitation is calculated by at least one frequency band.

EEE 6. The computer-implemented method of any one of EEEs 3-5,
wherein the excitation is extracted from a game audio matrix arranged by:
   dividing individual game audio sounds based on frames of the game,
   calculating for each frame, an excitation of at least one frequency band for the individual game audio sound, and
   arranging the calculated excitations in a game audio matrix according to the number of frames and the at least one frequency band of the individual game audio sound.

EEE 7. The computer-implemented method of any one of EEEs 3-6,
wherein the loudness is calculated based on a masking of the excitation of the candidate game object in relation to another candidate game object.

EEE 8. The computer-implemented method of any one of EEEs 2-7,
wherein identifying candidate game audio objects further comprises using a listener-centered trigger zone to identify the non-silent in-game audio emitters.

EEE 9. The computer-implemented method of any one of EEEs 2-8, further comprising,
converting the non-silent in-game audio emitter's position, relative to a listener-centered position in the game, to normalized Cartesian coordinates.

EEE 10. A decoder comprising a processor configured to perform the method according to any one of EEEs 2-9.

EEE 11. A device comprising a memory and a processor configured to perform the method according to any one of EEEs 1-9.

EEE 12. A computer program having, instructions which when executed by an electronic device causes the electronic device to perform the method according to any one of EEEs 1-9.

EEE 13. A computer-readable medium having stored thereon a computer program according to EEE 12.

EEE 14. An audio system for playback of game audio by use of representative audio objects, comprising a memory and at least one pre-processor configured to perform the method according to EEE 1, and a memory and a processor configured to perform the method according to any one of EEEs 2-9.

EEE 15. The audio system according to EEE 14, wherein the memory and at least one pre-processor configured to perform the method according to EEE 1 are included in a server, and the memory and processor configured to perform the method according to any one of EEEs 2-9 are included in a mobile device, and the server and mobile device are configured to communicate with each other.

1-15. (canceled)

16. A computer-implemented method for creating information associated with game audio and representative audio objects in an offline stage for use in a game audio reproduction system, comprising the steps of,
dividing individual game audio sounds based on frames of the game, calculating for each frame, an excitation of at least one frequency band for the individual game audio sound, and
arranging the calculated excitations in a game audio matrix according to the number of frames and the at least one frequency band of the individual game audio sound.

17. A computer-implemented method for playback of game audio by use of representative audio objects at runtime, comprising frame-by-frame the steps of,
identifying candidate game audio objects using non-silent in-game audio emitters, calculating a perceptual importance of each of the candidate game objects using associated metadata in context of the game audio scene, and
generating a pre-set number of representative gaming audio objects using the perceptual importance for playback of the game audio scene at runtime.

18. The computer-implemented method of claim 17, wherein the metadata comprises an excitation, a position, a distance scale, a loudness, a sound object category, and/or a spatial relationship among candidate objects.

19. The computer-implemented method of claim 18, wherein the excitation is a modified excitation calculated based on an original excitation and a distance scale.

20. The computer-implemented method of claim 18, wherein the excitation is calculated by at least one frequency band.

21. The computer-implemented method of claim 18,
wherein the excitation is extracted from a game audio matrix arranged by:
dividing individual game audio sounds based on frames of the game,
calculating for each frame, an excitation of at least one frequency band for the individual game audio sound, and
arranging the calculated excitations in a game audio matrix according to the number of frames and the at least one frequency band of the individual game audio sound.

22. The computer-implemented method of claim 18, wherein the loudness is calculated based on a masking of the excitation of the candidate game object in relation to another candidate game object.

23. The computer-implemented method of claim 17, wherein identifying candidate game audio objects further comprises using a listener-centered trigger zone to identify the non-silent in-game audio emitters.

24. The computer-implemented method of claim 17, further comprising, converting the non-silent in-game audio emitter's position, relative to a listener-centered position in the game, to normalized Cartesian coordinates.

25. The computer-implemented method of claim 17, further comprising creating the metadata based on game events and the game audio matrix.

26. A decoder comprising a processor configured to perform the method of claim 17.
